(19) United States
(12) Patent Application Publication
(10) Pub. No.: US 2026/0255229 A1
(43) Pub. Date: Aug. 27, 2026

(54) MANAGING MOBILITY IN NETWORKS SUPPORTING DUAL CONNECTIVITY

(71) Applicant: Nokia Technologies Oy, Espoo (FI)

(72) Inventors: Panagiotis SPAPIS, Munich (DE); Ahmad AWADA, Munich (DE); Umur KARABULUT, Munich (DE); Amaanat ALI, Espoo (FI); Srinivasan SELVAGANAPATHY, Bangalore (IN); Subramanya CHANDRASHEKAR, Bangalore (IN)

(21) Appl. No.: 18/995,524

(22) PCT Filed: Jun. 20, 2023
(86) PCT No.: PCT/EP2023/066562

§ 371 Date: Jan. 16, 2025

(30) Foreign Application Priority Data
Aug. 8, 2022 (IN) 202241045223

(51) Int. Cl. H04W 36/00; H04W 76/15

(52) U.S. Cl. CPC H04W 36/0069; H04W 36/0058; H04W 76/15

(57) ABSTRACT

A 5G new radio network that supports dual connectivity for user equipment allows the user equipment to access the network concurrently via a primary and secondary cell. Radio coverage in the primary cell is supported by a master distributed node controlled by a master central node, while radio coverage in the secondary cell is supported by a secondary distributed node controlled by a secondary central node. Embodiments seek to support lower layer dual connectivity mobility of the user equipment by providing coordination between the master and secondary cells such that a handover decision can be made at a master distributed node based on lower layer measurements.

### TECHNOLOGICAL FIELD

Various example embodiments relate to facilitating handover between cells in a new radio network for a user equipment configured to support dual connectivity.

### BACKGROUND

New radio 5G networks may comprise network nodes that are formed in a distributed way such that there is a central node or unit that controls multiple distributed nodes or units, each distributed node supports providing radio coverage via one or more cells. These cells may be smaller than macro cells and thus, movement between cells may occur more frequently.

Lower layer mobility LLM is being considered for such networks, where handover decisions are made in a distributed node based on lower layer signal measurements performed at the user equipment. Complexity may arise for user equipment that are configured to support dual connectivity such that the user equipment is enabled to connect concurrently to a primary distributed node providing access to a primary serving cell and a secondary distributed node providing access to a secondary serving cell. A handover in the primary cell may affect the configuration of the connection with the secondary cell.

### BRIEF SUMMARY

The scope of protection sought for various embodiments of the disclosure is set out by the independent claims. The embodiments and features, if any, described in this specification that do not fall under the scope of the independent claims are to be interpreted as examples useful for understanding various embodiments of the invention.

According to various, but not necessarily all, embodiments of the disclosure there is provided a user equipment for accessing a radio access network comprising a master central node and a plurality of master distributed nodes supporting providing radio coverage via primary cells, said master central node controlling said plurality of master distributed nodes, and a secondary central node and at least one secondary distributed node supporting providing radio coverage via at least one secondary cell, said secondary central node controlling said at least one secondary distributed node, wherein said user equipment is configured to support dual connectivity such that the user equipment is enabled to connect concurrently to a primary distributed node providing access to a primary serving cell and a secondary distributed node providing access to a secondary serving cell, wherein said user equipment comprises: at least one processor; and at least one memory storing instructions that, when executed by the at least one processor, cause the user equipment at least to: establish a dual connectivity connection towards the primary serving cell and the secondary serving cell, receive from a master node a measurement configuration for performing measurements related to at least a non-serving master cell and a secondary cell for enabling the serving master distributed node to perform a lower layer mobility dual connectivity handover decision, perform at least part of the configured measurements, and transmit a measurement report related to the performed measurements towards the serving master distributed node via a lower layer message.

It was recognised that for a user equipment that is configured to support dual connectivity, then where a lower layer mobility dual connectivity handover decision is made at the serving master distributed node with respect to a primary cell change, this may affect the configuration of the connection with the secondary cell both in the situation where the serving secondary cell remains the same and in the situation where it changes. Where for example, the serving secondary cell is situated across a primary cell border or where a secondary cell is itself being changed, then the allocated bands at the secondary cell may change when the primary cell is changed and thus, the measurements that facilitate any handover decision may include measurements related to the secondary cell.

Thus, in order for the serving master distributed node to be able to make an informed lower layer dual connectivity handover decision, a user equipment may be provided with measurement configuration information related to at least a non-serving master cell and a secondary cell. This allows the user equipment to respond by performing at least some of the configured measurements and transmitting a report related to the measurements towards the serving master distributed node allowing it to make an informed dual connectivity handover decision as it will have relevant information relating both to the updated secondary cell configuration that such a handover will trigger and the updated primary cell.

In some example embodiments, said measurement report relates to at least a non-serving master cell and a secondary cell.

In some example embodiments, the measurement configuration includes a first configuration comprising MCG config 1 and an associated SCG config 1, and a second configuration comprising MCG config 2 and an associated SCG config 2.

SCG Config 1 may be the configuration of a secondary cell that it is compatible with the configuration MCG config 1 of the distributed node of one target primary cell, while SCG config 2 may be the configuration of the same secondary cell that is compatible with the configuration MCG config 2 of the distributed node of another of the target primary cells. The secondary cell may be a target secondary cell or it may be the current serving secondary cell.

In some example embodiments MCG config 1 includes a PCell Id of a first non-serving master distributed node and SCG config 1 includes at least one PSCell Id (secondary cell identifier) of at least one secondary distributed node.

In some example embodiments, said measurement configuration is received from said serving master distributed node as a layer 2 message.

In some example embodiments, said measurements comprise at least one of the following: layer one signal strength or layer one signal quality measurements.

The secondary serving cell may also be referred to as a primary secondary cell and a serving node may be referred to as a source node.

In some example embodiments, said user equipment is further configured to receive a cell change indication indicating a change in primary serving cell and a change in configuration of said secondary cell, said cell change indication being received as part of a layer 2 message.

In some example embodiments, said layer 2 message comprises a MAC CE message triggering said cell change.

In some example embodiments, said indication is received from said serving master distributed node to which said measurements were sent.

In some example embodiments, said cell change indication may comprise a configuration ID indicating a configuration to use for said primary cell and for said secondary cell in said cell change.

In some example embodiments, said user equipment is further configured to respond to receipt of said cell change indication by initiating a connection procedure with an updated primary serving cell and with said secondary serving cell.

Where the secondary cell has not changed but the configuration has changed, then the connection will be suspended during this procedure.

In some example embodiments, said connection procedure may comprise a random access procedure.

In some example embodiments, said received cell change indication includes a change of said secondary serving cell; and said user equipment is responsive to receipt of said cell change indication to initiate a connection procedure with said updated primary serving cell and with an updated secondary serving cell.

In some example embodiments, said measurement configuration received from said serving master distributed node is received in a radio resource reconfiguration message.

In some example embodiments, said plurality of said primary cells comprise target cells and said one or more secondary cell comprises at least one of the following: a target or serving cell.

In some example embodiments, said user equipment is configured to use said received radio resource configuration information when performing said connection procedure.

According to various, but not necessarily all, embodiments of the disclosure there is provided according to a further aspect a master distributed node for supporting radio coverage via a primary cell and for providing access to said primary cell to a user equipment, said user equipment being configured to support dual connectivity such that said user equipment is enabled to connect concurrently to said master distributed node and a secondary distributed node providing access to a serving secondary cell, said master distributed node becoming on connection of said user equipment a serving master distributed node for said user equipment and providing access to a primary serving cell, said master distributed node comprising at least one processor; and at least one memory storing instructions that, when executed by the at least one processor, cause the master distributed node at least to: receive from said user equipment a measurement report relating to at least a non-serving master cell and in response to said measurement report to make a lower layer mobility dual connectivity handover decision.

In some example embodiments the master distributed node is configured to make a handover decision for both the secondary and primary cell based on measurements from at least one target primary cell.

In some example embodiments said received measurement report relates to at least said non-serving primary cell and a secondary cell.

Example embodiments provide a measurement report from a user equipment to a serving master distributed node relating to at last a target master cell and a secondary cell allowing the master distributed node to make lower layer mobility dual connectivity handover decisions based on measurements for both the primary and secondary cells.

In some example embodiments, said distributed node is further configured following making said handover decision: to generate a cell change indication indicating a change in primary serving cell; and to transmit said cell change indication as part of a layer 2 message towards said user equipment.

In some example embodiments said cell change indication may comprise a configuration ID indicating configuration to use for said primary cell and said secondary cell in said cell change.

In some example embodiments, said layer 2 message is transmitted towards said user equipment as part of a MAC CE message.

In some example embodiments, said cell change indication further comprises an indication of a cell change for said secondary serving cell.

In some example embodiments, said distributed node is further configured to forward a message to said user equipment comprising measurement configuration information related to at least a non-serving master cell and a secondary cell; and to transmit said message as part of a radio resource control reconfiguration message towards said user equipment.

In some example embodiments, said configuration for performing measurements related to at least a non-serving master cell and a secondary cell further comprises configuration for connecting to at least a non-serving master cell and a secondary cell.

In some example embodiments, said measurement configuration information is received from said central master node as part of an L3 message and is forwarded as an L2 message.

In other embodiments, rather than receive and simply forward the measurement configuration information, it may be received and processed at the distributed node or it may be generated at the distributed node prior to transmission towards the user equipment.

In some example embodiments, said distributed node is configured to receive from a central node controlling said distributed node, an indication of target primary cells' configurations and at least one secondary cell for which measurements are required and to generate measurement configuration information for said indicated target primary cells and said at least one secondary cell and to transmit said measurement configuration information to said central node.

In other example embodiments, said distributed node is configured to receive from a central node controlling said distributed node, a request for its measurement configuration, the central node generating measurement and connection configuration information for said target primary cells and said at least one secondary cell in response to receiving the distributed node's measurement configuration.

In some example embodiments said at least one secondary cell comprises a serving secondary cell, in some example embodiments, said at least one secondary cell comprises at least one target secondary cell.

Target primary and secondary cells are those prepared for lower layer mobility which are potential handover targets.

According to various, but not necessarily all, embodiments of the disclosure there is provided according to a yet further aspect a central node for controlling a plurality of distributed nodes configured to support providing radio coverage via primary cells to a user equipment, said user equipment being configured to support dual connectivity by concurrent connection to a serving master distributed node supporting providing radio coverage via a primary serving cell and a serving secondary distributed node supporting providing radio coverage via a secondary serving cell, said central node comprising: at least one processor; and at least one memory storing instructions that, when executed by the at least one processor, cause the central node at least to: determine at least one non-serving master cell to be prepared for lower layer mobility; generate and transmit information indicating said at least one determined non-serving master cell to a secondary central node controlling a plurality of secondary distributed nodes configured to support providing radio coverage via secondary cells to said user equipment; and receive secondary cell configuration information for a secondary cell related to said at least one non-serving master cell.

The plurality of primary cells may be potential target cells for the lower layer mobility handover.

In some example embodiments, said central node is configured to generate and transmit said information as a secondary node modification signal.

In some example embodiments, said central node is configured to generate and transmit said information as a secondary node addition request signal.

In some example embodiments, said central node is further configured to: generate a measurement and connection configuration request indicating a plurality of primary cells and at least one secondary cell for which measurement information is required for enabling a serving master distributed node to perform a lower layer mobility dual connectivity handover decision with respect to said plurality of primary and said at least one secondary cells; and transmit said measurement and connection configuration request to said serving master distributed node; receive said measurement and connection configuration information from said serving master distributed node; and to generate reconfiguration information for said plurality of primary cells and said at least one secondary cell; and to transmit said reconfiguration information to said serving master distributed node.

In some example embodiments, said central node is further configured to: generate a measurement and connection configuration request requesting the measurement and connection configuration of the serving master distributed node; and transmit said measurement and connection configuration request to said serving master distributed node; receive said measurement and connection configuration information from said serving master distributed node; generate measurement and connection configuration information for a plurality of primary and said at least one secondary cells; and to generate reconfiguration information for said plurality of primary cells and said at least one secondary cell; and to transmit said reconfiguration information to said serving master distributed node.

According to various, but not necessarily all, embodiments of the disclosure there is provided a system for providing a radio access network supporting lower layer mobility for a user equipment configured for dual connectivity said system comprising: a master central node according to a yet further aspect; a plurality of master distributed nodes according to a further aspect supporting providing radio coverage via primary cells, said master central node controlling said plurality of master distributed nodes; a secondary central node for controlling at least one secondary distributed node; and the at least one secondary distributed node supporting providing radio coverage via at least one secondary cell.

According to various, but not necessarily all, embodiments of the disclosure there is provided a method performed at a user equipment for accessing a radio access network comprising a master central node and a plurality of master distributed nodes supporting providing radio coverage via primary cells, said master central node controlling said plurality of master distributed nodes, and a secondary central node and at least one secondary distributed node supporting providing radio coverage via one or more secondary cells, said secondary central node controlling said at least one secondary distributed node, wherein said user equipment is configured to support dual connectivity such that the user equipment is enabled to connect concurrently to a primary distributed node providing access to a primary serving cell and a secondary distributed node providing access to a secondary serving cell, wherein said method comprises: establishing a dual connectivity connection towards the primary serving cell and the secondary serving cell; receiving from a master node a measurement configuration for performing measurements related to at least a non-serving master cell and a secondary cell for enabling the serving master distributed node to perform a lower layer mobility dual connectivity handover decision; performing at least a part of the configured measurements; transmitting a report relating to the performed measurements towards the serving master distributed node via a lower layer message.

According to various, but not necessarily all, embodiments of the disclosure there is provided a computer program comprising instructions which when executed by a user equipment cause said user equipment to: establish a dual connectivity connection towards a primary serving cell and a secondary serving cell; receive from a master node a measurement configuration for performing measurements related to at least a non-serving master cell and a secondary cell for enabling the serving master distributed node to perform a lower layer mobility dual connectivity handover decision; perform at least a part of the configured measurements; transmit a report relating to the performed measurements towards the serving master distributed node via a lower layer message.

According to various, but not necessarily all, embodiments of the disclosure there is provided a non-transitory computer readable medium comprising program instructions stored thereon for performing at least the following: establishing a dual connectivity connection towards a primary serving cell and a secondary serving cell; and in response to receipt of a measurement configuration for performing measurements related to at least a non-serving master cell and a secondary cell from a master node the measurements enabling the serving master distributed node to perform a lower layer mobility dual connectivity handover decision; performing at least a part of the configured measurements.

According to various, but not necessarily all, embodiments of the disclosure there is provided a method performed at a distributed node for supporting radio coverage via a primary cell and for providing access to said primary cell to a user equipment, said user equipment being configured to support dual connectivity such that said user equipment is enabled to connect concurrently to said master distributed node and a secondary distributed node providing access to a serving secondary cell, said master distributed node becoming a serving master distributed node for said user equipment on said and providing access to a primary serving cell, said method comprising: receiving from said user equipment a measurement report relating to at least a non-serving master cell; and in response to said measurement report making a lower layer mobility dual connectivity handover decision for said user equipment.

According to various, but not necessarily all, embodiments of the disclosure there is provided a computer program comprising instructions which when executed by a distributed node cause said distributed node to: receive from said user equipment a measurement report relating to at least a non-serving master cell; and in response to said measurement report make a lower layer mobility dual connectivity handover decision for said user equipment.

According to various, but not necessarily all, embodiments of the disclosure there is provided a non-transitory computer readable medium comprising program instructions stored thereon for performing at least the following: in response to receipt of a measurement report relating to at least a non-serving master cell from a user equipment making a lower layer mobility dual connectivity handover decision for said user equipment.

According to various, but not necessarily all, embodiments of the disclosure there is provided a method performed at a central node for controlling a plurality of distributed nodes configured to support providing radio coverage via primary cells to a user equipment, said user equipment being configured to support dual connectivity by concurrent connection to a serving master distributed node supporting providing radio coverage via a primary serving cell and a serving secondary distributed node supporting providing radio coverage via a secondary serving cell, said method comprising: determining at least one non-serving master cell to be prepared for lower layer mobility; generating and transmitting information indicating said at least one determined non-serving master cell to a secondary central node controlling a plurality of secondary distributed nodes configured to support providing radio coverage via secondary cells to said user equipment; and receiving secondary cell configuration information for a secondary cell related to said at least one non-serving master cell.

According to various, but not necessarily all, embodiments of the disclosure there is provided a computer program comprising instructions which when executed by a central node cause said central node to: generate a measurement and connection configuration request indicating a plurality of primary cells and at least one secondary cell for which measurement information is required for enabling a serving master distributed node to perform a lower layer mobility dual connectivity handover decision with respect to said plurality of primary and said at least one secondary cells; and transmit said measurement and connection configuration request to said serving master distributed node.

According to various, but not necessarily all, embodiments of the disclosure there is provided a user equipment for accessing a radio access network comprising a master central node and a plurality of master distributed nodes supporting providing radio coverage via primary cells, said master central node controlling said plurality of master distributed nodes, and a secondary central node and at least one secondary distributed node supporting providing radio coverage via at least one secondary cell, said secondary central node controlling said at least one secondary distributed node, wherein said user equipment is configured to support dual connectivity such that the user equipment is enabled to connect concurrently to a primary distributed node providing access to a primary serving cell and a secondary distributed node providing access to a secondary serving cell, wherein said user equipment comprises: means for establishing a dual connectivity connection towards the primary serving cell and the secondary serving cell; means for receiving from a master node a measurement configuration for performing measurements related to at least a non-serving master cell and a secondary cell for enabling the serving master distributed node to perform a lower layer mobility dual connectivity handover decision; means for performing at least a part of the configured measurements; and means for transmitting a report relating to the performed measurements towards the serving master distributed node via a lower layer message.

In some example embodiments, said user equipment further comprises means for receiving a cell change indication indicating a change in primary serving cell and a change in configuration of said secondary cell, said cell change indication being received as part of a layer 2 message.

In some example embodiments, said means for establishing said dual connectivity connection is configured to respond to receipt of said cell change indication by initiating a connection procedure with said updated primary serving cell and with said secondary serving cell.

In some example embodiments, said received cell change indication includes a change of said secondary serving cell; and said means for establishing dual connectivity is responsive to receipt of said cell change indication to initiate a connection procedure with said updated primary serving cell and with said updated secondary serving cell.

According to various, but not necessarily all, embodiments of the disclosure there is provided a master distributed node for supporting radio coverage via a primary cell and for providing access to said primary cell to a user equipment, said user equipment being configured to support dual connectivity such that said user equipment is enabled to connect concurrently to said master distributed node and a secondary distributed node providing access to a serving secondary cell, said master distributed node becoming on connection of said user equipment a serving master distributed node for said user equipment and providing access to a primary serving cell, said master distributed node comprising: means for receiving from said user equipment a measurement report relating to at least a non-serving master cell and a secondary cell; and means for determining handover decisions, said means for determining handover decisions being responsive to said received measurement report to make a lower layer mobility dual connectivity handover decision for said user equipment.

In some example embodiments, said distributed node further comprises means for generating a cell change indication message in response to said handover decision, said cell change indication indicating a change in primary serving cell; and means for transmitting said cell change indication towards said user equipment.

In some example embodiments, said distributed node further comprises means for forwarding a message to said user equipment, said message comprising measurement configuration information related to at least a non-serving master cell and a secondary cell.

In some example embodiments, said distributed node comprises means for receiving from a central node controlling said distributed node, an indication of target primary cells' configurations and at least one secondary cell for which measurements are required; and means for generating measurement and connection configuration information for said indicated target primary cells and said at least one secondary cell; and means for transmitting said measurement and connection configuration information to said central node.

According to various, but not necessarily all, embodiments of the disclosure there is provided according to a yet further aspect a central node for controlling a plurality of distributed nodes configured to support providing radio coverage via primary cells to a user equipment, said user equipment being configured to support dual connectivity by concurrent connection to a serving master distributed node supporting providing radio coverage via a primary serving cell and a serving secondary distributed node supporting providing radio coverage via a secondary serving cell, said central node comprising: means for determining at least one non-serving master cell to be prepared for lower layer mobility; means for transmitting information relating to said at least one determined non-serving master cell to a secondary central node controlling a plurality of secondary distributed nodes configured to support providing radio coverage via secondary cells to said user equipment; and means for receiving secondary cell configuration information for a secondary cell related to said at least one non-serving master cell.

In some example embodiments, said central node further comprises: means for generating a measurement and connection configuration request indicating a plurality of primary cells and at least one secondary cell for which measurement information is required for enabling a serving master distributed node to perform a lower layer mobility dual connectivity handover decision with respect to said plurality of primary and said at least one secondary cells; and means for generating reconfiguration information for said plurality of primary cells and said at least one secondary cell; wherein said means for transmitting is configured to transmit said measurement and connection configuration request towards said serving master distributed node; and said means for receiving is configured in response to receipt of said measurement and connection configuration information from said serving master distributed node to trigger said means for generating reconfiguration information for said plurality of primary cells and said at least one secondary cell to generate said reconfiguration information; and said means for transmitting is configured to transmit said reconfiguration information to said serving master distributed node.

According to various, but not necessarily all, embodiments of the disclosure there is provided according to a yet further aspect a central node for controlling a plurality of distributed nodes configured to support providing radio coverage via secondary cells to a user equipment, said user equipment being configured to support dual connectivity by concurrent connection to a serving master distributed node supporting providing radio coverage via a primary serving cell and a serving secondary distributed node supporting providing radio coverage via a secondary serving cell, said central node comprising: at least one processor; and at least one memory storing instructions that, when executed by the at least one processor, cause the central node at least to: receive information regarding master cells prepared for lower layer mobility; and generate configuration for at least one secondary cell compatible with said master cells prepared for lower layer mobility.

The central node controlling the secondary distributed nodes may respond to information regarding master cells that are prepared for lower layer mobility, that is target master cells by generating configuration information for one or more secondary cells that is compatible with the target master cells, in a way that inhibits the user equipment capabilities from being exceeded when it connects to the target master cell and the secondary cell.

The generated configuration information may include frequency layers and measurement identities that can be used by the secondary cell.

The central node may transit this configuration information in a secondary node addition or a secondary node modification response.

The central node may receive the information regarding master cells prepared for lower layer mobility from the central node controlling the master distributed nodes.

Further particular and preferred aspects are set out in the accompanying independent and dependent claims. Features of the dependent claims may be combined with features of the independent claims as appropriate, and in combinations other than those explicitly set out in the claims.

### BRIEF DESCRIPTION

Some example embodiments will now be described with reference to the accompanying drawings in which:

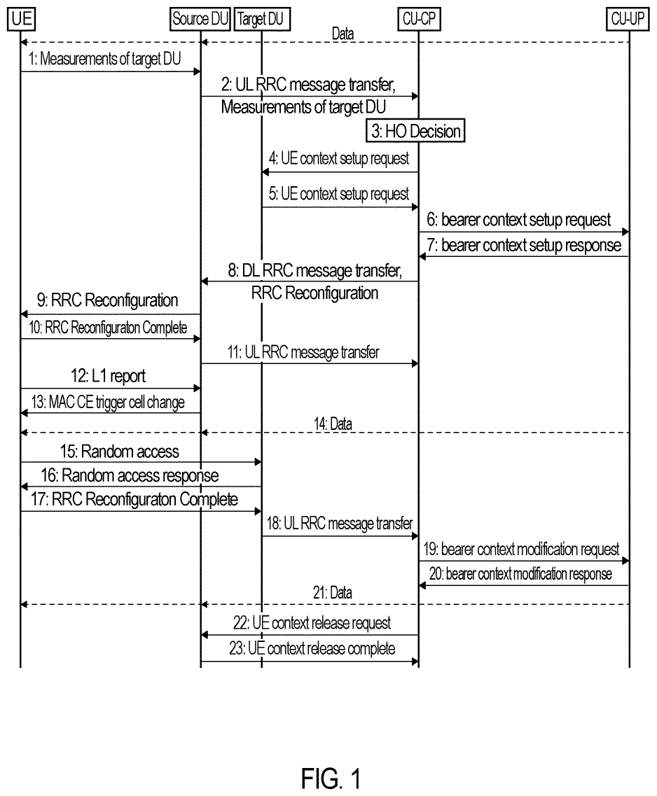

FIG. 1 shows an example message exchange that may be used to enable lower layer mobility;

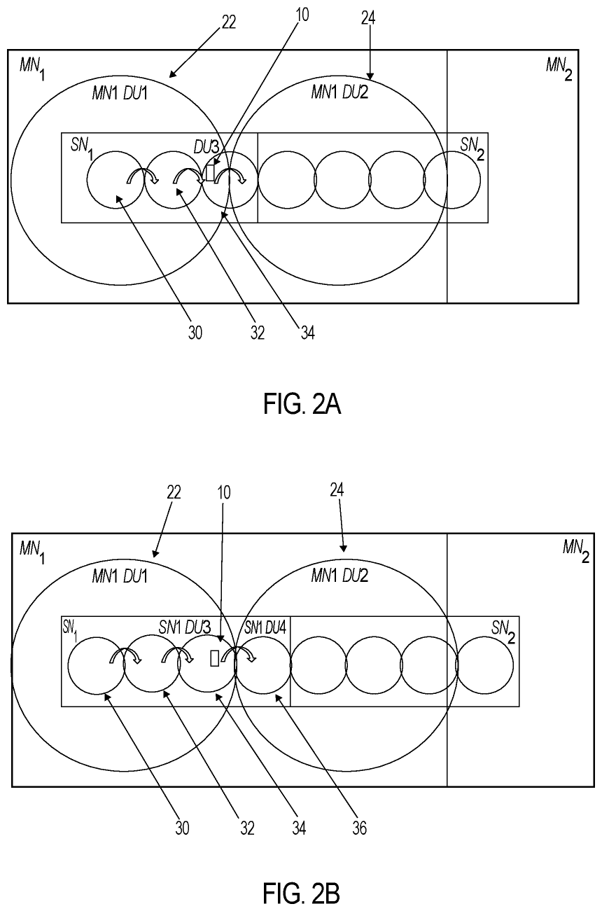

FIG. 2A schematically shows a user equipment handover where the master cell changes but the secondary serving cell does not change;

FIG. 2B shows a user equipment handover both master and secondary cell change;

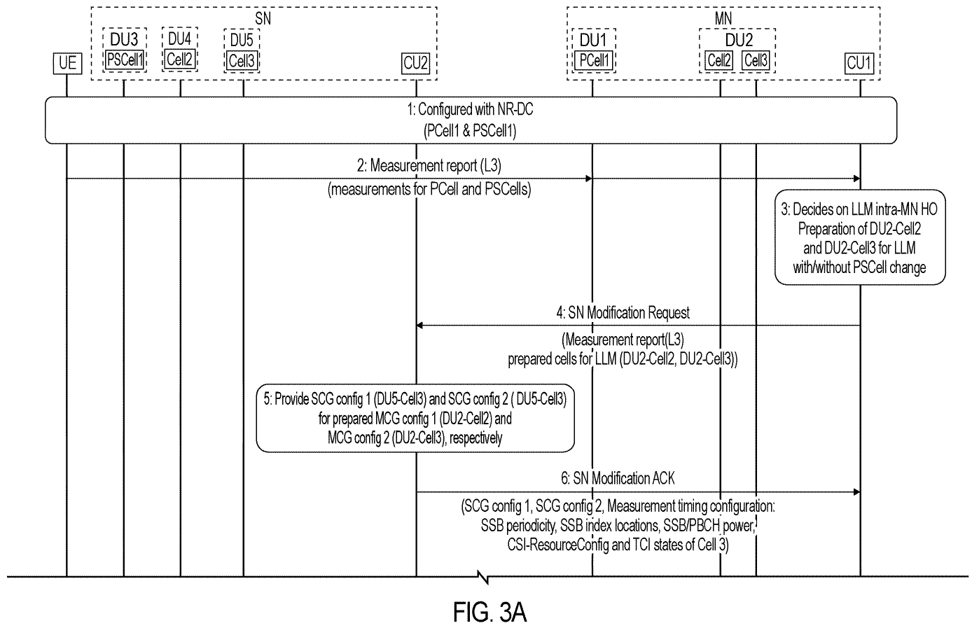

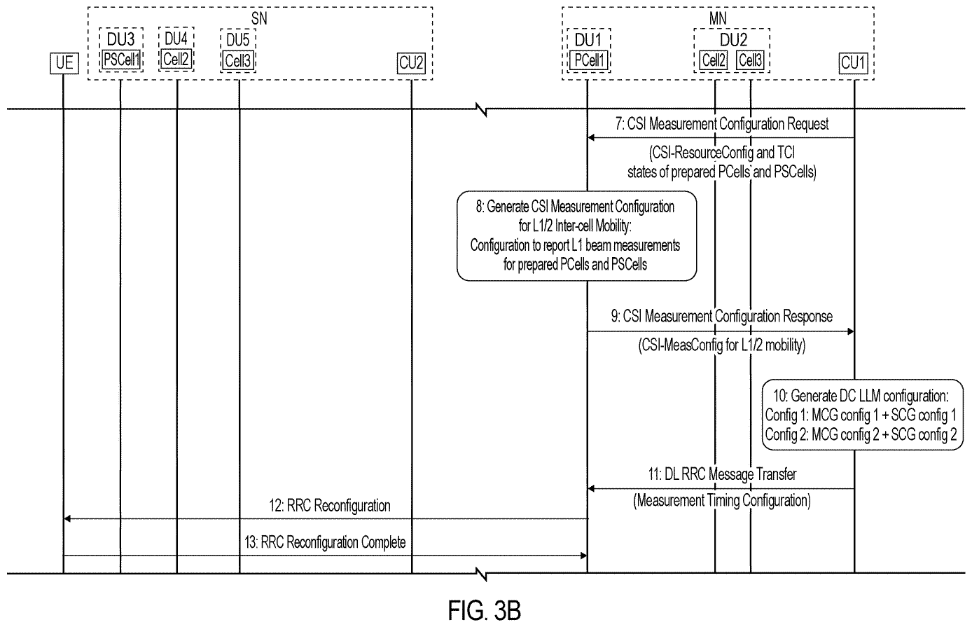

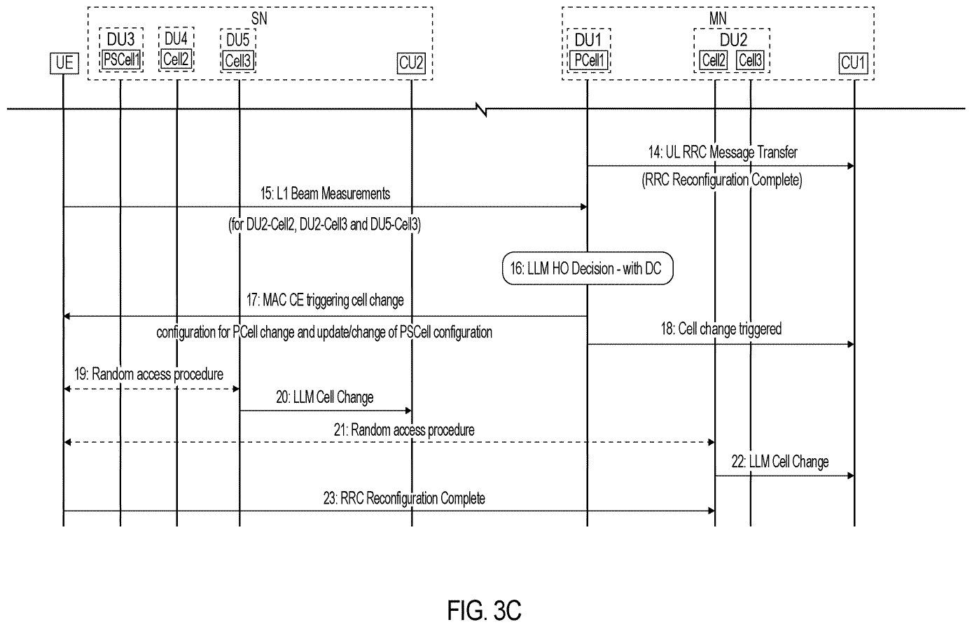

FIG. 3 show steps in a method where there is simultaneous intra master node handover with serving cell configuration modification where dual connectivity is set up before lower layer mobility;

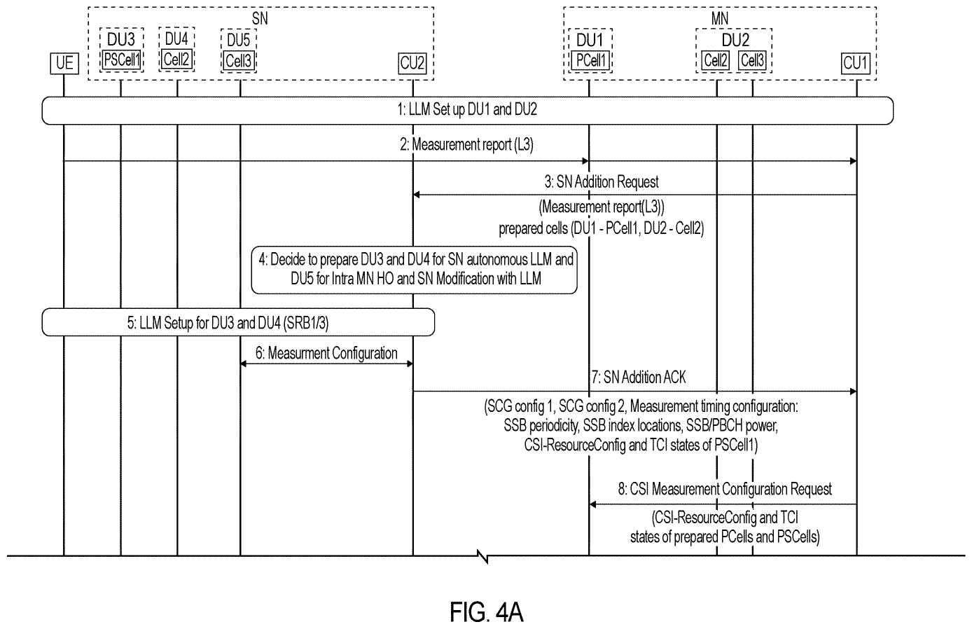

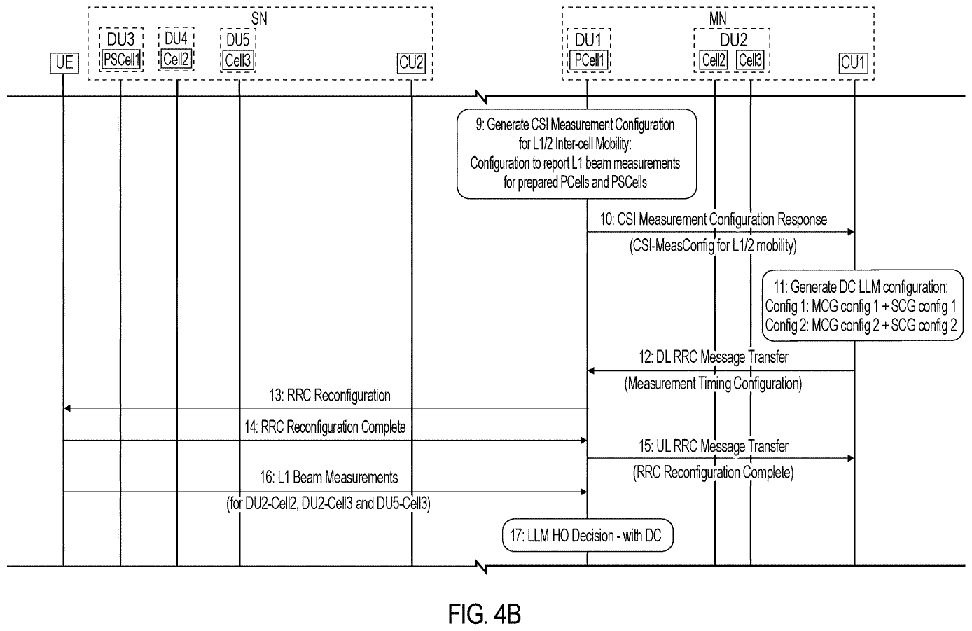

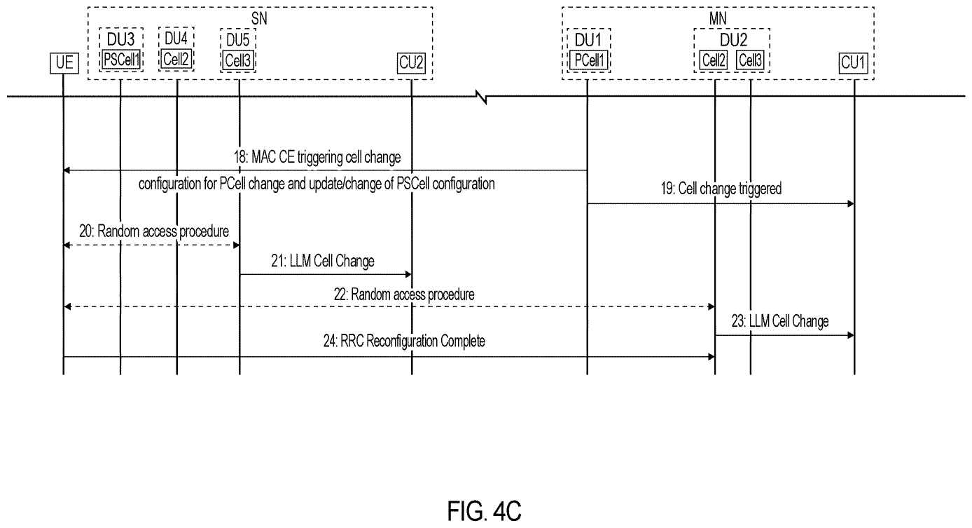

FIG. 4 show steps in a method where there is simultaneous master node and secondary node handover where lower layer mobility is set up before dual connectivity; and

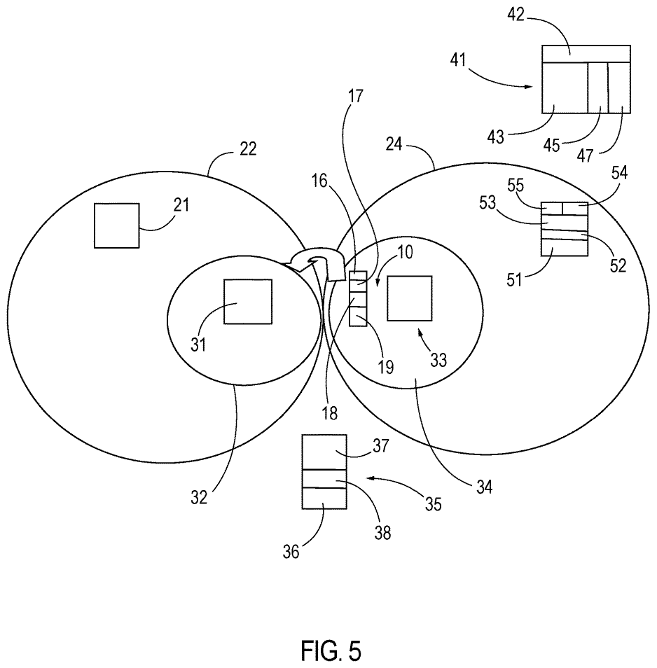

FIG. 5 illustrates a network comprising a master central node, master distributed nodes, a secondary central node and secondary distributed nodes according to an embodiment.

### DETAILED DESCRIPTION

Before discussing the example embodiments in any more detail, first an overview will be provided.

Lower Layer Mobility (LLM), marked also as L1/2 inter-cell mobility, is an upcoming objective to enhance mobility in new radio networks. According to the paradigm, the decision about the cell change is based on layer 1 measurements (physical layer) and is made at the L2 MAC (medium access control) layer in the Distributed Unit or node (DU). FIG. 1 schematically shows a message exchange for such an inter-DU LLM scenario. In brief: The UE provides the L3 measurements to the Source DU, which are forwarded to the CU-CP (central unit control plane) (step 1). Based on these measurements the CU-CP decides about the cell preparation (HO Decision) and proceeds in setting up the context in the target DU (steps 4-5). Then CU-CP communicates with CU-UP (central unit user plane) to perform the bearer context setup (steps 6-7).

In step 8 the CU-CP forwards the RRC Reconfiguration message to the Source DU using a DL RRC Message Transfer and the latter forwards it to the UE (step 9). UE responds with an RRC Reconfiguration Complete which is then forwarded to the CU-CP (steps 10-11).

The UE based on its configuration provides the periodic L1 reports to the Source DU (step 12).

Once the Source DU decides that the UE should be handed over to another DU (i.e., Target DU) it triggers the handover, using a MAC CE (step 13). Up to this point the UE receives data from the Serving DU.

Then the UE applies the RRC configuration for the target cell-indicated by the MAC CE and performs Random Access (RA) to it (steps 15-16). After the RA procedure, the UE transmits an RRC Reconfiguration Complete to the Target cell, which is forwarded to the CU-CP (steps 17-18).

The CU-CP performs bearer modification (steps 19-20) with the CU-UP, to update the bearer setup and for the latter to start forwarding the data to the Target DU (and stop forwarding data to the Source DU). Once this is completed the UE starts receiving data from the target DU (step 21).

Finally, the CU-CP releases the UE context from the Source DU with a UE Context Release Request (steps 22-23).

Thus, the handover decision is made at the DU using measurements from the lower layers. Where dual connectivity is supported issues may arise as changes to the primary cell may change the configuration of the secondary cell and/or the secondary cell may also change. Thus, the master distributed unit may need information regarding one or more secondary cells as well as information regarding target master cells in order to facilitate the making of the decision. This may require some coordination between master and secondary nodes.

It should be understood that the master central node and the secondary central node may in a disaggregated architecture be a single entity configured to control both the secondary distributed nodes and the master distributed nodes.

The issues that may arise with handover in a network where dual connectivity is supported are schematically illustrated in FIG. 2A and FIG. 2B. FIG. 2A shows intra master node MN (master node) handover without secondary node or cell modification while FIG. 2A shows intra MN handover with secondary node modification.

FIG. 2A shows two primary cells, 22 and 24 with respective master distributed nodes DU1 and DU2 and secondary cells 30, 32, 34. Primary cell 22 is the current serving cell of user equipment 10 while secondary cell 34 is the secondary serving cell for user equipment 10 and straddles the two primary cells 22, 24. User equipment 10 is shown moving between cells 30 and 32 and reaching cell 34. The handovers from cell 30 to 32 and 32 to 34 are without issue being within master cell 22 and thus, simply require secondary node modifications to be applied and do not require any coordination with the master node. However, when the user equipment 10 reaches cell 34 it may seek to handover from primary cell 22 to primary cell 24. Now although it is not changing the secondary cell remaining within cell 34, this change may need coordination between the master node and the secondary node as there are potential updates or changes in the distributed node configuration DU2 compared to that of DU1 that may affect the secondary cells. These configuration changes may include frequencies, bands, carriers, security keys etc. Since the secondary cell group configuration is influenced by the master cell group configuration then preparation and execution using lower layer mobility is not feasible unless some coordination between the master nodes and the secondary nodes is provided.

For example, if the master DU1 allocated bands to the UE are B1 and B2 and master distributed unit DU2 wants to change the allocation to B1, B4, B5 and that changes the secondary component carriers part then any change in serving secondary cell is completely dependent on whether or not the primary cell secondary carrier component has been executed and thus, in such scenarios coordination between the master node and the secondary node is required.

FIG. 2B shows the UE 10 moving from primary cell 22 to primary cell 24 and at the same time from secondary cell 34 to secondary cell 36. Thus, a handover for both the primary and the secondary cell is required. Again there are potential updates/changes in the master distributed node (DU1 and DU2) configurations in the frequencies, bands, carriers, security keys etc. and thus again, if the master node unit DU1 is allocated bands B1, B2, B3 to the UE but the master distributed unit 2 wants to change the allocation to B1, B4, B5 this will change the secondary cell group part and thus coordination is again required.

Embodiments, seek to provide coordination between the master node (MN) and secondary node (SN) to allow LLM handover decisions to be made at a serving master distributed node for user equipment supporting dual connectivity where these handovers will affect the secondary cell, either where there is simultaneous handovers at both master and secondary cell or because the configuration of the serving secondary cell will change as the master cell changes.

There are two scenarios considered, in the first: DC (dual connectivity) is already set up and the MN (master node) may inform the SN (secondary node) about which cells it will configure, this may be sent in a SN Modification request and the SN will respond by providing the secondary cell group SCG configuration for the required SN modification. MN is then able to prepare then the LLM configurations for both the secondary and master cells and provide them to the UE.

Scenario 2: In this case LLM is set up in the MN before DC. When the MN decides to set up DC, it provides the SN with information about which cells it has configured with LLM, in this case a SN Addition request is used. The SN will respond by providing the respective SCG configurations and the MN will then prepare the LLM configurations for both secondary and master cells and provide them to the UE.

Advantages of this coordination is that it enables LLM with DC which otherwise would not be possible in case of intra MN HO (handover) with different configurations.

The procedure of L1/L2 based inter-cell mobility are applicable to the following scenarios:
Standalone, CA and NR-DC (carrier aggregation and new radio-dual connectivity) case with serving cell change within one CG (configured grant)
Intra-DU case and intra-CU inter-DU case (applicable for Standalone and CA: no new RAN interfaces are expected)
Both intra-frequency and inter-frequency
Both FR1 (4.1 GHz to 7.125 GHz) and FR2 (24.25 GHz to 52.6 GHz)
Source and target cells may be synchronized or non-synchronized

As shown in FIGS. 2A and 2B we can differentiate two types of mobility when we have Dual Connectivity:
1) Intra SN (secondary node) modification—where the PSCell (primary or serving secondary group cell) changes within same SN,
2) Intra MN (master node) handover—where the PCell (primary cell) changes within same MN.

When the MN (master node) initiates the procedure to configure DC, it sends to the SN an SN Addition request message [TS37.340]. In this message it provides its configuration, including frequency layers and measurement identities that can be used by the SN, so as to ensure that the UE capabilities are not being exceeded. The SN has to comply with this configuration. When the UE performs an Intra MN handover, the above mentioned configuration may change and a new coordination may need to take place.

Embodiments seek to provide a framework to configure and enable LLM for a UE configured with dual connectivity.

Embodiments seek to:
1) Coordinate between the MN and the SN when the LLM is set up and the respective configurations that are provided to the UE.
2) Enable the simultaneous Intra MN HO and SN modification if this is needed
   a. enable the UE to provide target PSCell (primary secondary cell or secondary serving cell) measurements of the SN to the source DU of the MN
   b. enable the source MN DU to decide for the simultaneous Intra MN HO and SN modification based on the available measurements.

Methods for Coordination across nodes During Preparation Phase may involve at least one of:
1: Source MN indicates to the SN the list of PCells (primary cells) that are prepared for lower-layer mobility in MN.
2: SN generates LLM SCG (secondary cell group) configurations for prepared target PSCells of SN to be applied when lower-layer mobility is executed.
3: SN provides the MN with at least one of the IEs:
   SCG configurations for the prepared target PSCells of SN for lower-layer mobility
   Measurement timing configuration of the prepared target PSCells: SSB (synchronisation signal block) periodicity, SSB index locations, SS/PBC power
   CSI-Resource configuration (channel status information) and TCI (transmission configuration indicator) states of the prepared target PSCells.
4: CU of MN communicates with the serving DU of MN the CSI-Resource Configurations and TCI states of the prepared PSCells in SN.
5: Serving DU of MN generates a CSI (channel status information) Measurement configuration which includes configuration to report the L1 beam measurements for prepared target PCell and PSCells.

Methods to associate MCG and SCG configurations for LLM towards UE in RRC Signaling may include one or more of:
6: Source MN generates a DC lower layer mobility configuration that consists of MCG and SCG configurations for LLM in MCG and SCG.
   As example, For given TCI state of SCG there can be two target configurations for the UE to select from depending on the serving-cell of MCG
7: UE reports to the serving DU of MN L1 beam measurement results for target PCells and target PSCells.
   In this embodiment, UE may report the current TCI state of other CG when it send L1-measurement report to one CG. Based on TCI state of other CG, DU can decide on its switching action.
8: Serving DU decides on lower layer mobility using the L1 beam measurement received from the UE for target PCell and target PSCells.
9: UE receives from the serving DU a lower layer command to apply a stored DC configuration consisting of MCG and SCG config.

Two separate cases can be identified in the LLM and DC coordination:
Case 1: In case DC is already set up, the source MN may inform the SN about which prepared PCells it will configure for LLM in the SN modification Request and the SN will provide to the source MN the SCG configuration for the required SN modification. MN will prepare then the LLM configurations and provide them to the UE.
Case 2: In case LLM is set up in the MN and then the MN decides to set up DC, it proceeds in SN Addition request and provides which PCells it has configured with LLM. SN will provide the respective SCG configurations and the MN will prepare then the LLM configurations and provide them to the UE.

NOTE: In a disaggregated architecture, the gNB-CU is common for both MN and SN. They are distinguished by the DUs where MCG-DU (master configuration group-distributed unit) belongs to the MN and SCG-DU belongs to the SN.

FIG. 3 shows an example message exchange for the inter-DU LLM scenario, where dual connectivity is set up prior to setting up lower layer mobility.

The establishment of dual connectivity at the UE, which could be seen as step 0 involves the UE connecting to PCell1 of DU1 (of MN) and to PSCell1 of DU3 (of SN). DC establishment is described in Section 10.2 of TS37.340. The SN addition procedure involves the MN determining based on L3 measurements to provide the UE with resources from a SN. In particular a UE context is established at the SN in order to provide resources from the SN to the UE. For bearers requiring SCG (secondary cell group) radio resources, this procedure is used to add at least the initial SCG serving cell of the SCG.

Initially at step 1 the UE is configured to operate in NR-DC with a serving MN (served by PCell 1) and a serving SN (served by PSCell1). DU1 supports providing radio coverage in PCell1, and DU2 supports providing radio coverage in Cell2 and Cell3. DU3 supports providing radio coverage for the secondary serving cell, sometimes termed the primary secondary cell PSCell1. There are further secondary cells within this cell group cell2 and cell3, DU4 supporting providing radio coverage in cell2 and DU5 in cell 3 and all of these secondary distributed nodes are controlled by secondary central node CU2.

At step 2 the UE provides the L3 measurements to the serving master or source DU, DU1 and DU1 forwards these to the CU-CP (central unit-control plane) master node CU1.

At step 3: Based on the measurement report from the UE, the CU1 decides to set up LLM for the UE with potential target cells Cell2 and Cell3 of DU2.

At step 4: CU1 (of MN) sends an SN modification request (optional according to TS37.340) where it provides to the CU2 (of SN) the L3 measurement report for the serving and target cells of the SN, i.e., PSCell1, DU4-Cell2 and DU5-Cell3, and the list of prepared cells for LLM in the MN (Cell2 and Cell3 of DU2), as well as the respective configuration for these cells. Thus, at this point the CU of the MN sends information regarding the cells of the MN to the SN.

At step 5: CU2 decides about preparing cell configurations (DU5-Cell3 in the example) that are relevant for the DU2-Cell2 (SCG Config 1 for DU5-Cell3) and DU2-Cell3 (SCG Config 2 for DU5-Cell3). That is the CU2 considers the target master cells and prepares configuration for the secondary cells taking account of the target master cells. In this step the CU2 coordinates with DU5 to obtain the Measurement timing configurations including the SSB periodicity and index location, SSB/PBCH power, CSI Resource configuration, and TCI states of the DU5-Cell3.

At step 6: CU2 provides to the CU1 of the MN the following: SCG Config 1, SCG Config 2 and the Measurement timing configurations including the SSB periodicity and index location, SSB/PBCH power, CSI Resource configuration, and TCI states of the DU5-Cell3. This may be provided in the In the SN Modification ACK.

At steps 7-9: CU1 communicates with the (source or serving) DU (i.e., DU1) to generate the CSI measurement configuration. In this request it provides to the DU1 the target PCell configurations and the target PSCells configurations. The DU1 prepares the CSI measurement configuration for the target PCells and for the serving secondary cell PS Cell and in some cases target secondary cells, and provides it to the CU1.

Note: In alternative implementations the CU may ask DU1 to provide the measurement configuration of the Source DU and generate the CSI measurement configuration in the CU.

Step 10: CU1 generates the LLM RRC Configurations for the target PCells with DC (i.e., MCG config 1 and SCG config 1 and MCG config 2 and SCG config 2). SCG Config 1 is the configuration of Cell 3 that it is compatible with the configuration of DU2 Cell 2; SCG Config 2 is the configuration of Cell 3 that it is compatible with the configuration of DU2 Cell 3; each SCG Config is identified by a unique identifier and among other things it contains: Measurement timing configurations including the SSB periodicity and index location, SSB/PBCH power, CSI Resource configuration, and TCI states of the DU5-Cell3; it may also contain the Cell ID (e.g., PCI) of DU5-Cell3. It may also contain allocated frequency bands to be used/measured, frequency carriers to be used/measured and security keys to be used after the HO.

SCG Config 1 and SCG Config 2 are different because they have to be compatible with MCG Config 1 is the configuration of DU2 Cell 2; MCG Config 2 is the configuration of DU2 Cell 3; Similarly to SCG Config, the MCG config is identified by a unique identifier and among other things it contains: Measurement timing configurations including the SSB periodicity and index location, SSB/PBCH power, CSI Resource configuration, and TCI states of the DU5-Cell3; it may also contain the Cell ID (e.g., PCI). It may also contain allocated frequency bands to be used/measured, frequency carriers to be used/measured and security keys to be used after the HO.

Steps 11-14: CU1 provides to the UE the RRC Configuration for LLM with DC and MN responds with RRC Reconfiguration complete.

Step 15-18: The UE uses the Measurement timing configurations including the SSB periodicity and index location, SSB/PBCH power, CSI Resource configuration, and TCI states of the target cells in order to be able to perform measurements. Without this configuration it cannot perform L1 measurements.

The UE provides to the Source DU L1 measurement reports based on these measurements. These include measurements for DU2-Cell2, DU2-Cell3 and optionally DU5-Cell3. The UE will report using the Cell ID of the target cell, so it will provide a structure with at least a subset of the following measurements:
Measurements for serving cell
DU2-Cell2 measurement
DU2-Cell3 measurement
DU5-Cell3 measurement
Measurements of other target cells [if configured]

DU1 decides that the UE should perform LLM HO with DC and decides which target Pcell the UE should be handed over to. If the DU of the MN [step 16] receives a measurement with high DU2-Cell2 measurement and DU5-Cell3 measurement it will select MCG Config 1 and SCG Config 1. Then DU1 provides to the UE a MAC to trigger PCell change with PSCell configuration update/change and to the CU1 the information that it triggered LLM HO.

Steps 19-23: The UE concludes the LLM HO by accessing the target cells (PCell and PScell) and providing the RRC Reconfiguration complete to the CU1.

Note: Note that as FIG. 2A shows, the UE may remain in the same PSCell but just needs to apply a new configuration for that same cell.

One point to note is that a TCI state is a “Transmission Configuration Indicator” state and enables the UE to transmit and receive using one particular configuration. Each UE can be configured with multiple TCI states for the serving and the non serving cells and they are used to enable the transmission/reception. Based on the measurements when the MN DU decides the HO and to switch cell, then it will trigger the application of a new configuration. The UE will use the TCI state in the indicated configuration to start transmission/reception. The MN may use a different TCI state in the serving cell, considering the UE beam measurements, which will not result in a handover. Use of TCI states takes place in other transmission/reception configuration updates (e.g., in Inter Cell Beam Management).

Case 2: LLM is set up before DC (FIG. 4)

Initially at step 1: UE is served with PCell 1 of DU1 and is configured with LLM with prepared cells, i.e., Cell2 and Cell3 from the DU2.

Step 2: UE provides the measurement report to CU1 and the CU1 decides to set up DC.

Step 3: CU1 sends an SN Addition request where it provides to the CU2 (of SN) the L3 measurement report and the list of prepared cells (Cell2 and Cell3 of DU2) for LLM in the MN, as well as the respective configuration for these cells.

Steps 4-6: CU2 decides about setting up LLM with some DUs that do not require interaction with the MN, and Cell3 of DU5 which requires interaction with the MN. Then CU2 sets up LLM from PSCell of DU3 to Cell2 of DU4 with or without SRB3, whereas CU2 communicates with DU5 to take the CSI measurement configuration of that cell, together with the Measurement timing configurations including the SSB periodicity and index location, SSB/PBCH power, CSI Resource configuration, and TCI states of the DU5-Cell3.

Step 7: In the SN Addition ACK, CU2 provides to the MN the following: SCG Config 1 (for DU2 Cell2), SCG Config 2 (for DU2 Cell3) and the Measurement timing configurations including the SSB periodicity and index location, SSB/PBCH power, CSI Resource configuration, and TCI states of the DU5-Cell3.

Steps 8-10: CU1 communicates with the (source or serving) DU (i.e., DU1) to generate the CSI measurement configuration. In this request it provides to the DU1 the target PCell configurations and the Target PSCells configurations. The DU1 prepares the CSI measurement configuration for the target PCells and PSCells and provides it to the CU1.

Note: In alternative implementations the CU may ask DU1 to provide the measurement configuration of the Source DU and generate the CSI measurement configuration in the CU.

Step 11: CU1 generates the LLM RRC Configurations for the target PCells with DC (i.e., MCG config 1 and SCG config 1 and MCG config 2 and SCG config 2). SCG Config 1 is the configuration of Cell 3 that it is compatible with the configuration of DU2 Cell 2; SCG Config 2 is the configuration of Cell 3 that it is compatible with the configuration of DU2 Cell 3; each SCG Config is identified by a unique identifier and among other things it contains: Measurement timing configurations including the SSB periodicity and index location, SSB/PBCH power, CSI Resource configuration, and TCI states of the DU5-Cell3; it may also contain the Cell ID (e.g., PCI) of DU5-Cell3. It may also contain allocated frequency bands to be used/measured, frequency carriers to be used/measured and security keys to be used after the HO.

SCG Config 1 and SCG Config 2 are different because they have to be compatible with MCG Config 1 is the configuration of DU2 Cell 2; MCG Config 2 is the configuration of DU2 Cell 3; Similarly to SCG Config, the MCG config is identified by a unique identifier and among other things it contains: Measurement timing configurations including the SSB periodicity and index location, SSB/PBCH power, CSI Resource configuration, and TCI states of the DU5-Cell3; it may also contain the Cell ID (e.g., PCI). It may also contain allocated frequency bands to be used/measured, frequency carriers to be used/measured and security keys to be used after the HO.

Steps 12-15: CU1 provides to the UE the RRC Configuration for LLM with DC and MN responds with RRC Reconfiguration complete.

Steps 16-19: The UE uses the Measurement timing configurations including the SSB periodicity and index location, SSB/PBCH power, CSI Resource configuration, and TCI states of the target cells in order to be able to perform measurements. Without this configuration it cannot perform L1 measurements.

The UE provides to the Source DU L1 measurement reports based on these measurements. These include measurements for DU2-Cell2, DU2-Cell3 and optionally DU5-Cell3. The UE will report using the Cell ID of the target cell, so it will provide a structure with at least a subset of the following measurements:
Measurements for serving cell
DU2-Cell2 measurement
DU2-Cell3 measurement
DU5-Cell3 measurement
Measurements of other target cells [if configured]

DU1 decides that the UE should perform LLM HO with DC and decides which target Pcell the UE should be handed over to. If the DU of the MN [step 16] receives a measurement with high DU2-Cell2 measurement and DU5-Cell3 measurement it will select MCG Config 1 and SCG Config 1. Then DU1 provides to the UE a MAC to trigger PCell change with PSCell configuration update/change and to the CU1 the information that it triggered LLM HO.

Steps 20-24: The UE concludes the LLM HO by accessing the target cells (PCell and PScell) and providing the RRC Reconfiguration complete to the CU1.

Note: Note that as FIG. 2A shows, the UE may remain in the same PSCell but just needs to apply a new configuration for that same cell.

Embodiments may provide one or more of the following advantages:
Enable LLM with DC which is not possible in case of intra MN HO with different configurations.
Allow the serving DU in MN to make lower layer mobility decision based on L1 beam measurements for target PCells and target PSCells that are controlled by different SN.
In case of simultaneous Intra MN HO with SN modification, the configurations are provided to the UE with a single RRC Reconfiguration message instead of two which leads to signaling gains
In case of LLM in the SN the latter would need to trigger coordination with the MN before initiating the process; with this method the SN can do this proactively which leads to signaling gains.

FIG. 5 schematically shows a 5G new radio network according to an embodiment. This network comprises a plurality of primary cells 22, 24 and a plurality of secondary cells 32, 34. Radio coverage within primary cell 22 is supported by master distributed node 21 while master distributed node 26 supports providing radio coverage within primary cell 24. Master distributed node 21 and master distributed node 26 are both controlled by master central node 41.

There are secondary cells 32 and 34 and radio coverage in these cells is supported by secondary distributed nodes 31 and 33 respectively. Secondary distributed node 31 and secondary distributed node 33 are controlled by secondary central node 35. User equipment 10 is in this example currently connected to secondary cell 34 supported by secondary distribution node 33 and primary cell 24 supported by distributed node 26.

Thus, user equipment 10 is operating in a dual connectivity mode. In this example, user equipment 10 is moving from secondary cell 34 to secondary cell 32 and at the same time it is moving from master cell 24 to master cell 22.

Embodiments allow a handover decision regarding such a move to be made at the master distributed node 26 that is currently the master serving distributed node sometimes termed the source master distributed node for the user equipment 10.

User equipment 10 comprises a receiver 16 for receiving signals and this may be a means for receiving or circuitry configured to receive. User equipment 10 further comprises a means for establishing dual connectivity 17 which may be circuitry configured to established dual connectivity and a means for performing measurements 18 which again may be circuitry configured to perform measurements, which measurements may be L1 signal strength and/or quality measurements. User equipment 10 also comprises a transmitter 19 or means for transmitting. The receiver 16 may receive from distributed node 26 measurement configuration information for performing measurements related to a non-serving mater cell in this case cell 22 and a secondary cell in this case cell 32 these being the two cells for the target handover. The user equipment may respond to receipt of this by performing the measurements for these cells and transmitting the measurement report to the distributed node 26.

This is only an example and in other embodiments, there may be more cells for which measurement configuration information is received and measurements performed and in other embodiments, the serving secondary cell may straddle two master cells, in which case the measurements performed for the secondary cell may relate to the current serving secondary cell but the measurements may be for reconfigured frequency bands for example, for this cell.

The serving master distributed node 26 comprises a receiver 51 which may be receiving means or circuitry configured to receive that receives the measurement report and in response to this using decision making means 52 or circuitry configured to perform handover decisions makes a handover decision relating to the cells to handover to. The serving master distributed node 26 following making the handover decision uses means for generating or circuitry configured to generate a cell change indication 53 to generate a cell change indication that indicates any change in the primary serving cell and in the secondary cell determined in the handover decision. It then transmits this information towards the user equipment as part of a layer two message using means for transmitting 54.

Prior to the user equipment receiving the measurement configuration information and the steps above being performed there will have been some coordination between the secondary and master central nodes.

The serving master central node 41 will coordinate with the serving secondary central node 35 to determine the configuration of primary cells prepared for lower layer mobility and the corresponding changes that may be required in secondary cell configuration and/or the configuration of secondary cells prepared for lower layer mobility.

The master central node 41 use means for determining or circuitry configured to determine 43 to determine the primary cells prepared for lower layer mobility and will transmit this information towards the secondary central node 35 using transmitting means 45 or circuitry configured to transmit either as a secondary node addition request or a secondary node modification request.

The secondary central node 35 receives this information at receiver 37 and in response using means for generating configuration information 36 or circuitry configured to generate configuration information generates configuration for at least one secondary cell that is compatible with the master cells prepared for lower layer mobility and may transit this configuration information using transmitter 38 in a secondary node addition or a secondary node modification response.

The master central node 41 comprises means for receiving 47 or circuitry configured to receive and receives this secondary cell configuration information. The master central node 41 then liaises with the serving master distributed node to generate reconfiguration information for the primary cells and the at least one reconfigured secondary cell using means for generating or circuitry configured to generate a measurement configuration request 42, the configuration request indicating a plurality of primary cells and at least one secondary cell for which measurement information is required. This is transmitted to the serving master distributed node using the transmitting means 45.

The serving master distributed node 26 receives this at receiver 51 and forwards the measurement configuration information using means for forwarding 55 to the user equipment 10 so that the user equipment can perform the measurements described above.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021 June) section 3.2 incorporated by reference.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021 June) section 3.2 incorporated by reference.

A gNB Central Unit (gNB-CU) comprises e.g. a logical node hosting e.g. RRC (radio resource control), SDAP (service data adaptation protocol) and PDCP (packet data convergence protocol) protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC (radio link control), MAC (medium access control) and PHY (physical) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021 July) section 3.1 incorporated by reference.

Different functional splits between the central and distributed unit are possible, e.g. called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.

Or else, e.g. according to 3GPP TR 38.801 V14.0.0 (2017 March) Section 11 Incorporated by reference.

A gNB supports different protocol layers, e.g. Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:

The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. to segmentation;
Control channels include (BCCH, PCCH).

Layer 3 (L3) includes e.g. Radio Resource Control (RRC), e.g. according to 3GPP TS 38.300 V16.6.0 (2021 June) section 6 incorporated by reference.

A RAN (Radio Access Network) node or network node or central node or distributed node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021 June) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
   transfer unicast data to/from the UE;
   monitor control channels associated with the shared data channel to determine if data is scheduled for the data channel;
   provide channel quality and feedback information;
   perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-23. (canceled)

24. User equipment for accessing a radio access network comprising a master central node and a plurality of master distributed nodes supporting providing radio coverage via primary cells, said master central node controlling said plurality of master distributed nodes, and a secondary central node and at least a secondary distributed node supporting providing radio coverage via at least one secondary cell, said secondary central node controlling said at least one secondary distributed node, wherein said user equipment is configured to support dual connectivity such that the user equipment is enabled to connect concurrently to a primary distributed node providing access to a primary serving cell and a secondary distributed node providing access to a secondary serving cell, wherein said user equipment comprises:
at least one processor; and
at least one memory storing instructions that, when executed by the at least one processor, cause the user equipment at least to:
establish a dual connectivity connection towards the primary serving cell and the secondary serving cell,
receive from a serving master node a configuration for performing measurements related to at least a non-serving master cell and a secondary cell for enabling the serving master distributed node to perform a lower layer mobility dual connectivity handover decision,
perform at least part of the configured measurements,
transmit a report related to the performed measurements towards the serving master distributed node via a lower layer message.

25. User equipment according to claim 24, wherein said measurement report relates to at least a non-serving master cell and a secondary cell.

26. User equipment according to claim 24, wherein the measurement configuration includes a first configuration comprising master cell group configuration MCG config 1 and an associated secondary cell group configuration SCG config 1, and a second configuration comprising master cell group configuration MCG config 2 and an associated secondary cell group configuration SCG config 2.

27. User equipment according to claim 24, wherein said measurements comprise at least one of the following: layer one signal strength or layer one signal quality measurements.

28. User equipment according to claim 24, said user equipment being further configured to receive a cell change indication indicating a change in primary serving cell and a change in configuration of a secondary cell, said cell change indication being received as part of a layer 2 message.

29. User equipment according to claim 28, said user equipment being further configured to respond to receipt of said cell change indication by initiating a connection procedure with an updated primary serving cell and with said secondary serving cell.

30. User equipment according to claim 29, wherein said received cell change indication includes a change of said secondary serving cell; and
said user equipment is responsive to receipt of said cell change indication to initiate a connection procedure with said updated primary serving cell and with an updated secondary serving cell.

31. User equipment according to claim 24, wherein said measurement configuration is received from said serving master distributed node in a radio resource reconfiguration message.

32. A master distributed node for supporting radio coverage via a primary cell and for providing access to said primary cell to a user equipment, said user equipment being configured to support dual connectivity such that said user equipment is enabled to connect concurrently to said master distributed node and a secondary distributed node providing access to a serving secondary cell, said master distributed node becoming on connection of said user equipment a serving master distributed node for said user equipment and providing access to a primary serving cell, said master distributed node comprising at least one processor; and at least one memory storing instructions that, when executed by the at least one processor, cause the master distributed node at least to:
receive from said user equipment a measurement report relating to at least a non-serving master cell and in response to said measurement report to make a lower layer mobility dual connectivity handover decision.

33. A master distributed node according to claim 32, wherein said received measurement report relates to at least said non-serving master cell and a secondary cell.

34. A master distributed node according to claim 32, said master distributed node being further configured following making said handover decision:
to generate a cell change indication indicating a change in primary serving cell and a change in configuration of secondary cell; and
to transmit said cell change indication as part of a layer 2 message towards said user equipment.

35. A master distributed node according to claim 34, wherein said cell change indication further comprises an indication of a cell change for said secondary serving cell.

36. A master distributed node according to claim 32, said master distributed node being further configured to forward a message to said user equipment comprising configuration for performing measurements related to at least a non-serving master cell and a secondary cell; and
to transmit said message as part of a radio resource control reconfiguration message towards said user equipment.

37. A master distributed node according to claim 32, said master distributed node being configured to receive from a central node controlling said master distributed node, an indication of target primary cells' configurations and at least one secondary cell for which measurements are required and to generate measurement and connection configuration information for said indicated target primary cells and said at least one secondary cell and to transmit said measurement and connection configuration information to said central node.

38. A central node for controlling a plurality of distributed nodes configured to support providing radio coverage via primary cells to a user equipment, said user equipment being configured to support dual connectivity by concurrent connection to a serving master distributed node supporting providing radio coverage via a primary serving cell and a serving secondary distributed node supporting providing radio coverage via a secondary serving cell, said central node comprising:
at least one processor; and
at least one memory storing instructions that, when executed by the at least one processor, cause the central node at least to:
determine at least one non-serving master cell to be prepared for lower layer mobility;
generate and transmit information indicating said at least one determined non-serving master cell to a secondary central node controlling a plurality of secondary distributed nodes configured to support providing radio coverage via secondary cells to said user equipment; and
receive secondary cell measurement and connection configuration information for a secondary cell related to said at least one non-serving master cell.

39. A central node according to claim 38, said central node being configured to generate and transmit said information as a secondary node modification signal.

40. A central node according to claim 38, said central node being configured to generate and transmit said information as a secondary node addition request signal.

41. A central node according to claim 38, said central node being further configured to:
generate a measurement and connection configuration request indicating a plurality of primary cells and at least one secondary cell for which measurement information is required for enabling a serving master distributed node to perform a lower layer mobility dual connectivity handover decision with respect to said plurality of primary and said at least one secondary cells; and
transmit said measurement and connection configuration request to said serving master distributed node;
receive said measurement and connection configuration information from said serving master distributed node; and
to generate reconfiguration information for said plurality of primary cells and said at least one secondary cell; and
to transmit said reconfiguration information to said serving master distributed node.

42. A central node according to claim 38, said central node being further configured to:
generate a measurement and connection configuration request requesting the measurement configuration of the serving master node; and
transmit said measurement and connection configuration request to said serving master distributed node;
receive said measurement and connection configuration information from said serving master distributed node;
generate measurement and connection configuration information for a plurality of primary and said at least one secondary cells; and
to generate reconfiguration information for said plurality of primary cells and said at least one secondary cell; and
to transmit said reconfiguration information to said serving master distributed node.

43. A method performed at a user equipment for accessing a radio access network comprising a master central node and a plurality of master distributed nodes supporting providing radio coverage via primary cells, said master central node controlling said plurality of master distributed nodes, and a secondary central node and at least one secondary distributed node supporting providing radio coverage via at least one secondary cell, said secondary central node controlling said at least one secondary distributed node, wherein said user equipment is configured to support dual connectivity such that the user equipment is enabled to connect concurrently to a primary distributed node providing access to a primary serving cell and a secondary distributed node providing access to a secondary serving cell, wherein said method comprises:
establishing a dual connectivity connection towards the primary serving cell and the secondary serving cell;
receiving from a master node a configuration for performing measurements and connecting to at least a non-serving master cell and a secondary cell for enabling the serving master distributed node to perform a lower layer mobility dual connectivity handover decision;
performing at least a part of the configured measurements,
transmitting a report relating to the performed measurements towards the serving master distributed node via a lower layer message.
